(19) United States
(12) Patent Application Publication
(10) Pub. No.: US 2025/0373089 A1
(43) Pub. Date: Dec. 4, 2025

(54) Wireless Charging Modem Device

(71) Applicant: Tyrone Hinds, Stockbridge, GA (US)

(72) Inventor: Tyrone Hinds, Stockbridge, GA (US)

(21) Appl. No.: 19/222,203

(22) Filed: May 29, 2025

Related U.S. Application Data
(60) Provisional application No. 63/655,783, filed on Jun. 4, 2024.

(51) Int. Cl. H02J 50/80; H02J 50/00; H02J 50/10; H04L 49/35

(52) U.S. Cl. CPC H02J 50/80; H02J 50/005; H02J 50/10; H04L 49/35

(57) ABSTRACT

A wireless charging modem device is disclosed which is a wireless Wi-Fi charger that leverages inductive charging technology to wirelessly power smart devices. The wireless charging modem device comprises a router component that is configured to be plugged into the home's power and internet fiber line. The router component is similar to an internet router, but with wireless charging antennas as well. The router component includes status lights for power, internet, Wi-Fi, and ethernet ports. The device comprises a mobile application which users can utilize on their smart device to monitor a device's charging status and receive notifications about the charging process, including alerts for full charges or interruptions. The Wi-Fi feature allows remote control and management of the charging, so users may schedule charging sessions or activate the charger remotely.

### CROSS-REFERENCE TO RELATED APPLICATION

The present application claims priority to, and the benefit of, U.S. Provisional Application No. 63/655,783, which was filed on Jun. 4, 2024, and is incorporated herein by reference in its entirety.

### FIELD OF THE INVENTION

The present invention relates generally to the field of wireless charging modem devices. More specifically, the present invention relates to a device that allows a smart device to be charged by a wireless connection. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in wireless charging modem devices. Generally, traditional charging technology requires that a smart device be connected to a power source for charging. Further, current charging technology does not have Wi-Fi capability.

One resolution to the cumbersome use of charge cords has been the introduction of electromagnetic induction technology or wireless charging. Induction technology is employed in a wide range of applications, both commercially and within the house. For example, applications which inductively include power transfer are the recharging of electric vehicles, the charging of electric toothbrushes, and powering smart tags and security tags. Such induction technology, however, has not been broadly transferred to portable electronic devices. Further, a user of the wireless charger typically has to place the electronic device to be charged on the desktop or countertop within range of the wireless charger. By within range, it is herein meant that the electronic device to be charged is in contact with the wireless charger, such that the electronic device can receive power wirelessly transmitted from the wireless charger.

Accordingly, there is a demand for an improved wireless charging modem device that allows smart devices to be charged by a wireless connection. More particularly, there is a demand for a wireless charging modem device that allows a charging device to be connected to a home or office network.

Therefore, there exists a long felt need in the art for a wireless charging modem device that allows smart device to be charged by a wireless connection. There is also a long felt need in the art for a wireless charging modem device that allows a charging device to be connected to a home or office network. Further, there is a long felt need in the art for a wireless charging modem device that provides the charging device with a Wi-Fi connection while charging. Moreover, there is a long felt need in the art for a device that utilizes a mobile application to control wireless charging of the smart device. Further, there is a long felt need in the art for a wireless charging modem device that allows users to share files or stream media via the wireless charging device. Finally, there is a long felt need in the art for a wireless charging modem device that allows a user use to schedule their charging sessions via the mobile application.

The subject matter disclosed and claimed herein, in one embodiment thereof, comprises a wireless charging modem device. The device is a wireless Wi-Fi charger that leverages inductive charging technology to wirelessly power smart devices. The wireless charging modem device comprises a router component that is configured to be plugged into the home's power and internet fiber line. The router component is similar to an internet router, but with wireless charging antennas as well. The router component includes status lights for power, internet, Wi-Fi, and ethernet ports. Further, a lightning bolt indicator is lit whenever the router component is emitting wireless power. The device comprises a mobile application which users can utilize on their smart device to monitor a device's charging status and receive notifications about the charging process, including alerts for full charges or interruptions. The Wi-Fi feature allows remote control and management of the charging, so users may schedule charging sessions or activate the charger remotely. Users can share files or steam media as the wireless charging device may facilitate data transfer between the smart device and other network-connected devices.

In this manner, the wireless charging modem device of the present invention accomplishes all of the forgoing objectives and provides users with a device that charges smart devices wirelessly. The device also provides Wi-Fi to the charging device. The device is typically centrally located in the building or house.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wireless charging modem device. The device is a wireless Wi-Fi charger that leverages inductive charging technology to wirelessly power smart devices. The wireless charging modem device comprises a router component that is configured to be plugged into the home's power and internet fiber line. The device comprises a mobile application which users can utilize on their smart device to monitor a device's charging status. The Wi-Fi feature allows remote control and management of the charging, so users may schedule charging sessions or activate the charger remotely.

In one embodiment, the wireless charging modem device is an innovative new internet modem/router for the home and office, which also provides wireless charging power to devices in the building and facilitates data transfer between devices, all in one. The wireless charging modem device is a multi-function device that comprises air charging technology that wirelessly charges compatible smart devices through the air. The device also includes Wi-Fi connectivity which connects devices to a home or office network. Further, the device includes smart device mobile application and controls, such as a dedicated mobile application that remotely monitors, controls, and manages the charging process and status of connected smart devices. Finally, the device includes data transfer capabilities which facilitate data transfer between devices on the same network for seamless file sharing, media streaming, etc.

In one embodiment, the wireless charging modem device comprises a router component that is configured to be plugged into the home's power and internet fiber line via the illustrated power and internet cords. The router component can be any suitable shape and size as is known in the art, as long as the router component is shaped and sized to retain a primary charging circuit, as well as circuitry for providing a Wi-Fi connection. The primary charging circuit is well known in the art and can be any known configuration or circuitry for providing inductive power transfer. Thus, the router component is similar to an internet router, but with wireless charging antennas as well. Further, the router component includes Wi-Fi connectivity and circuitry which connects devices to a home or office network.

In one embodiment, the router component comprises a wireless power-transmitting component which communicates with a smart device to charge it. The router component also comprises a control logic that is capable of transferring power received to the wireless power-transmitting component. Typically, the router component comprises a power cord through which the router component receives electrical power from a standard power source, such as a 120 V outlet commonly found in residential and office buildings or a 12 V source as is commonly used in the auto industry. The router component is then capable of wirelessly transmitting power via the power-transmitting component to a smart device or other device to be charged.

In one embodiment, the wireless power-transmitting device includes a transmit coil and transmit circuitry. For example, the transmit circuitry may produce an alternating voltage, having a predetermined frequency, from a direct current voltage supplied to the transmit circuitry during operation of the device and supply the produced alternating voltage to the transmit coil. Also, by way of example, the transmit circuitry may produce a predetermined level of intensity of an inductive field in the transmit coil.

In one embodiment, the control logic of the router component controls operation of the device. The control logic may comprise hardware alone (i.e., circuitry) or may include both hardware and software. The control logic can be implemented by one of ordinary skill in the electronic arts without undue experimentation using technology that is known in the art. This technology may include, for example, application specific integrated circuits, a microprocessor executing code that is designed to implement the functions and methods described herein, programmable logic arrays, etc. The control logic is capable of transferring power received by the router component to the wireless power-transmitting component. The control logic may transfer the power directly to the wireless power-transmitting component. For example, the control logic may supply the transmit circuitry with direct current voltage provided to the control logic from receive circuitry.

In one embodiment, the router component will have a display mechanism for providing a user with an indication of the operating status of the wireless charger. The display mechanism may include, for example, a charging indicator (i.e., an LED) that indicates to a user that the wireless charger is receiving power. The charging indicator may light up, for example, when the device is receiving power. Further, the router component can also include status lights for internet, Wi-Fi, and ethernet ports. Additionally, a lightning bolt indicator is lit whenever the router component is emitting wireless power. In particular embodiments, the charging indicator may comprise a signal-strength meter, allowing the user to place the wireless charging modem device in a location where the signal transmitting the power is the strongest.

In one embodiment, the wireless charging modem device communicates with a mobile application on a smart device or other device needing charged. The mobile application is a dedicated application that remotely monitors, controls, and manages the charging process and status of the smart devices. Generally, the mobile application is downloaded onto the smart device needing charged and allows a user to monitor a smart device's charging status and receive notifications about the charging process. Further, the mobile application alerts the user of when the smart device is fully charged and/or if any interruptions in charging have occurred. The mobile application also allows for remote control of the charging and charge management, such that users can schedule charging sessions or activate the charger device remotely. Thus, scheduling of charging sessions helps with energy efficiency, especially if multiple devices are needing charged. The mobile application can also manage internet and Wi-Fi connectivity of multiple smart devices in communication with the wireless charging modem device. The Wi-Fi connectivity also allows remote control and management of the charging, so users may schedule charging sessions or activate the charger remotely via the mobile application.

In one embodiment, the mobile application also manages and facilitates data transfers between smart devices on the same network for seamless file sharing, media streaming, and more. Thus, users can share files or stream media via the wireless charging modem device and can facilitate data transfer between the smart device and other network-connected devices, as needed.

In one embodiment, the wireless charging modem device is placed in a central location within a house or building and can wirelessly charge smart devices that are set up with the mobile application and within range of the wireless charging modem device.

In one embodiment, the control logic is capable of operating the wireless power-transmitting component to wirelessly transmit power in accordance with a selectable power-transmitting protocol. These embodiments are referred to herein as programmable embodiments. In particular embodiments, the power-transmitting protocol is selected by a user of the device. In particular embodiments, the power-transmitting protocol may be selected by the smart device to be charged via the mobile application.

In particular embodiments, a selectable power-transmitting protocol may include, for example, a particular frequency at which the transmit circuitry produces an alternating voltage that the transmit circuitry supplies to the transmit coil. Thus, selecting a first power-transmitting protocol may cause the transmit circuitry to produce an alternating voltage at a particular frequency and selecting a second power-transmitting protocol may cause the transmit circuitry to produce and alternating voltage at a different frequency. Analogously, a particular power-transmitting protocol may include, for example, a particular level of intensity of an inductive field for the transmitting coil. Thus, selecting a first power-transmitting protocol may cause the transmit circuitry to produce a particular level of intensity of the inductive field, whereas selecting a second power-transmitting protocol may cause the transmit circuitry to produce a different level of intensity for the inductive field. Further, the control logic can select a power-transmission protocol that is suited for charging a particular smart phone.

For example, a smart device to be charged may be placed within range of the wireless charging modem device. If the smart device, via the mobile application, is capable of detecting that it is within range of the wireless charging modem device and is capable of wirelessly communication with the device, the smart device to be charged may transmit an identification of a power-transmitting protocol for the wireless charging modem device to use when the device charges the smart device. The wireless charging modem device may receive the transmitted identification of a wireless power-transmitting protocol and transmit power to the smart device in accordance with the identified protocol.

In yet another embodiment, the wireless charging modem device comprises a plurality of indicia.

In yet another embodiment, a method of wirelessly charging a smart device is disclosed. The method includes the steps of providing a wireless charging modem device comprising a router component with Wi-Fi capabilities. The method also comprises connecting the router component to the home's power and internet fiber line. Further, the method comprises downloading the mobile application on a smart device. The method also comprises utilizing the mobile application to manage wireless charging and Wi-Fi capabilities with the router component. The method comprises wirelessly charging the smart device via the router component and mobile application. Finally, the method comprises sharing files and streaming media between smart phones connected to the router component.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the wireless charging modem device of the present invention showing the router component in accordance with the disclosed architecture;

FIG. 2 illustrates a perspective view of one embodiment of the wireless charging modem device of the present invention showing the router component in accordance with the disclosed architecture;

FIG. 3 illustrates a perspective view of one embodiment of the wireless charging modem device of the present invention showing the router component in accordance with the disclosed architecture;

FIG. 4 illustrates a perspective view of one embodiment of the wireless charging modem device of the present invention showing the router component in accordance with the disclosed architecture;

FIG. 5 illustrates a perspective view of one embodiment of the wireless charging modem device of the present invention showing the router component in accordance with the disclosed architecture;

FIG. 6 illustrates a perspective view of one embodiment of the wireless charging modem device of the present invention showing the router component in accordance with the disclosed architecture;

FIG. 7 illustrates a perspective view of one embodiment of the wireless charging modem device of the present invention showing the mobile application on the smart device in accordance with the disclosed architecture;

FIG. 8 illustrates a perspective view of one embodiment of the wireless charging modem device of the present invention showing the device in use in accordance with the disclosed architecture;

FIG. 9 illustrates a perspective view of one embodiment of the wireless charging modem device of the present invention in accordance with the disclosed architecture; and

FIG. 10 illustrates a flowchart showing the method of wirelessly charging a smart device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a wireless charging modem device that allows smart devices to be charged by a wireless connection. There is also a long felt need in the art for a wireless charging modem device that allows a charging device to be connected to a home or office network. Further, there is a long felt need in the art for a wireless charging modem device that provides the charging device with a Wi-Fi connection while charging. Moreover, there is a long felt need in the art for a device that utilizes a mobile application to control wireless charging of the smart device. Further, there is a long felt need in the art for a wireless charging modem device that allows users to share files or stream media via the wireless charging device. Finally, there is a long felt need in the art for a wireless charging modem device that allows a user use to schedule their charging sessions via the mobile application.

The present invention, in one exemplary embodiment, is a novel wireless charging modem device. The device is a wireless Wi-Fi charger that leverages inductive charging technology to wirelessly power smart devices. The wireless charging modem device comprises a router component that is configured to be plugged into the home's power and internet fiber line. The router component is similar to an internet router, but with wireless charging antennas as well. The device comprises a mobile application which users can utilize on their smart device to monitor a device's charging status and receive notifications about the charging process, including alerts for full charges or interruptions. The Wi-Fi feature allows remote control and management of the charging, so users may schedule charging sessions or activate the charger remotely. The present invention also includes a novel method of wirelessly charging a smart device. The method includes the steps of providing a wireless charging modem device comprising a router component with Wi-Fi capabilities. The method also comprises connecting the router component to the home's power and internet fiber line. Further, the method comprises downloading the mobile application on a smart device. The method also comprises utilizing the mobile application to manage wireless charging and Wi-Fi capabilities with the router component. The method comprises wirelessly charging the smart device via the router component and mobile application. Finally, the method comprises sharing files and streaming media between smart phones connected to the router component.

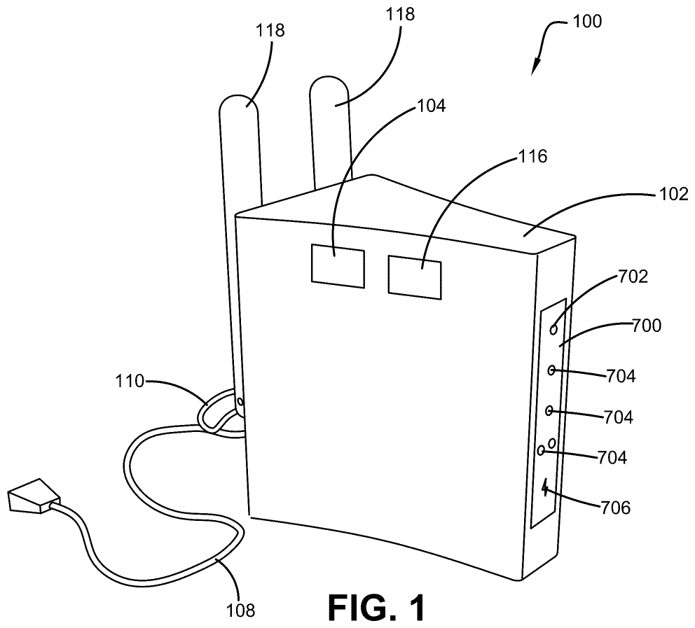

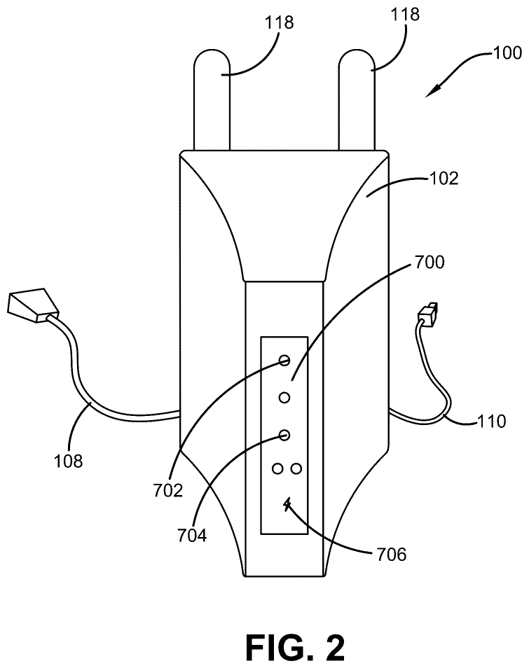

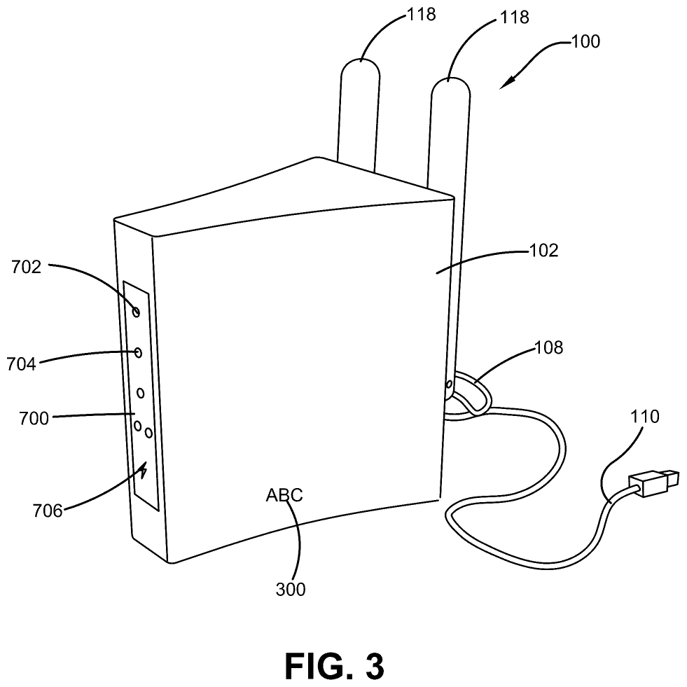

Referring initially to the drawings, FIGS. 1-3 illustrate a perspective view of one embodiment of the wireless charging modem device 100 of the present invention. In the present embodiment, the wireless charging modem device 100 is an improved wireless charging modem device 100 that provides a user with a means for wirelessly charging smart devices 106. Specifically, the wireless charging modem device 100 comprises a router component 102 with Wi-Fi capabilities 104 that is configured to be plugged into the home's power 108 and internet fiber 110 line. The device 100 comprises a mobile application 112 which users 114 can utilize on their smart device 106 to monitor a device's charging status. The Wi-Fi capabilities 104 allows remote control and management of the charging, so users 114 may schedule charging sessions or activate the charger device 100 remotely.

Generally, the wireless charging modem device 100 is an innovative new internet modem/router for the home and office, which also provides wireless charging power to devices in the building and facilitates data transfer between devices, all in one. The wireless charging modem device 100 is a multi-function device that comprises air charging technology that wirelessly charges compatible smart devices 106 through the air. The device 100 also includes Wi-Fi connectivity 104 which connects devices to a home or office network. Further, the device 100 includes smart device mobile application 112 and controls, such as a dedicated mobile application 112 that remotely monitors, controls, and manages the charging process and status of connected smart devices 106. Finally, the device 100 includes data transfer capabilities which facilitate data transfer between devices 106 on the same network for seamless file sharing, media streaming, etc.

Further, the wireless charging modem device 100 comprises a router component 102 that is configured to be plugged into the home's power 108 and internet fiber 110 line via the illustrated power 108 and internet 110 cords. The router component 102 can be any suitable shape and size as is known in the art, as long as the router component 102 is shaped and sized to retain a primary charging circuit 116, as well as circuitry for providing a Wi-Fi connection 104. The primary charging circuit 116 is well known in the art and can be any known configuration or circuitry for providing inductive power transfer. Thus, the router component 102 is similar to an internet router, but with wireless charging antennas 118 as well. Further, the router component 102 includes Wi-Fi connectivity 104 and circuitry which connects smart devices 106 to a home or office network.

In yet another embodiment, the wireless charging modem device 100 comprises a plurality of indicia 300. The router component 102 of the device 100 may include advertising, a trademark, or other letters, designs, or characters, printed, painted, stamped, or integrated into the router component 102, or any other indicia 300 as is known in the art. Specifically, any suitable indicia 300 as is known in the art can be included, such as but not limited to, patterns, logos, emblems, images, symbols, designs, letters, words, characters, animals, advertisements, brands, etc., that may or may not be router, wireless charging, or brand related.

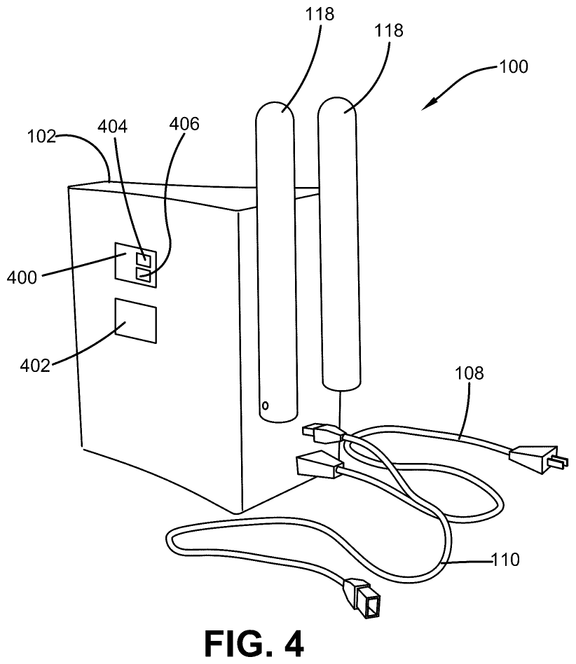

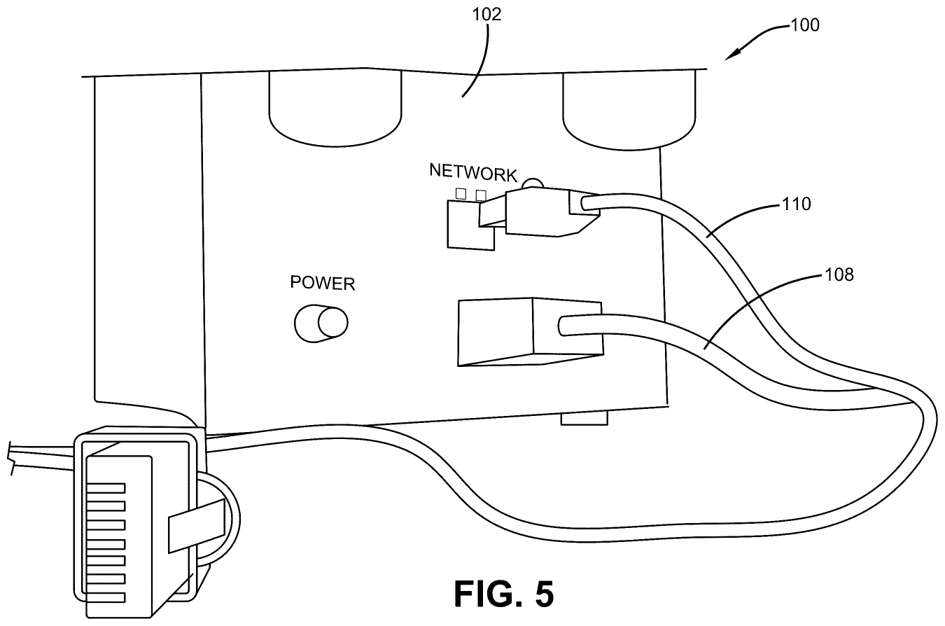

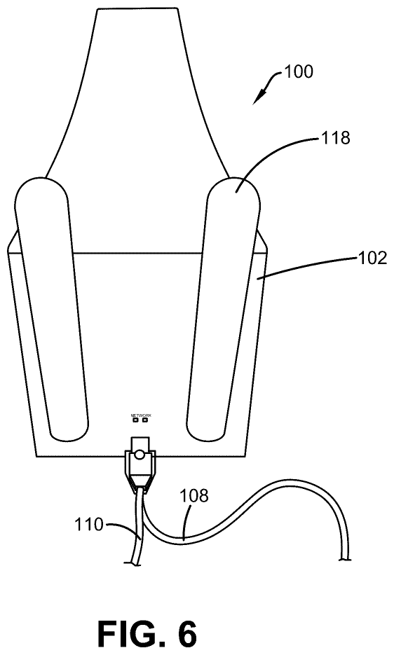

As shown in FIGS. 4-6, the router component 102 comprises a wireless power-transmitting component 400 which communicates with a smart device 106 to charge it. The router component 102 also comprises a control logic 402 that is capable of transferring power received to the wireless power-transmitting component 400. Typically, the router component 102 comprises a power cord 108 through which the router component 102 receives electrical power from a standard power source, such as a 120 V outlet commonly found in residential and office buildings or a 12 V source as is commonly used in the auto industry. The router component 102 is then capable of wirelessly transmitting power via the power-transmitting component 400 to a smart device 106 or another device to be charged.

In one embodiment, the wireless power-transmitting component 400 includes a transmit coil 404 and transmit circuitry 406. For example, the transmit circuitry 406 may produce an alternating voltage, having a predetermined frequency, from a direct current voltage supplied to the transmit circuitry 406 during operation of the device 100 and supply the produced alternating voltage to the transmit coil 404. Also, by way of example, the transmit circuitry 406 may produce a predetermined level of intensity of an inductive field in the transmit coil 404.

Generally, the control logic 402 of the router component 102 controls operation of the device 100. The control logic 402 may comprise hardware alone (i.e., circuitry) or may include both hardware and software. The control logic 402 can be implemented by one of ordinary skill in the electronic arts without undue experimentation using technology that is known in the art. This technology may include, for example, application specific integrated circuits, a microprocessor executing code that is designed to implement the functions and methods described herein, programmable logic arrays, etc. The control logic 402 is capable of transferring power received by the router component 102 to the wireless power-transmitting component 400. The control logic 402 may transfer the power directly to the wireless power-transmitting component 400. For example, the control logic 402 may supply the transmit circuitry 406 with direct current voltage provided to the control logic 402 from receive circuitry.

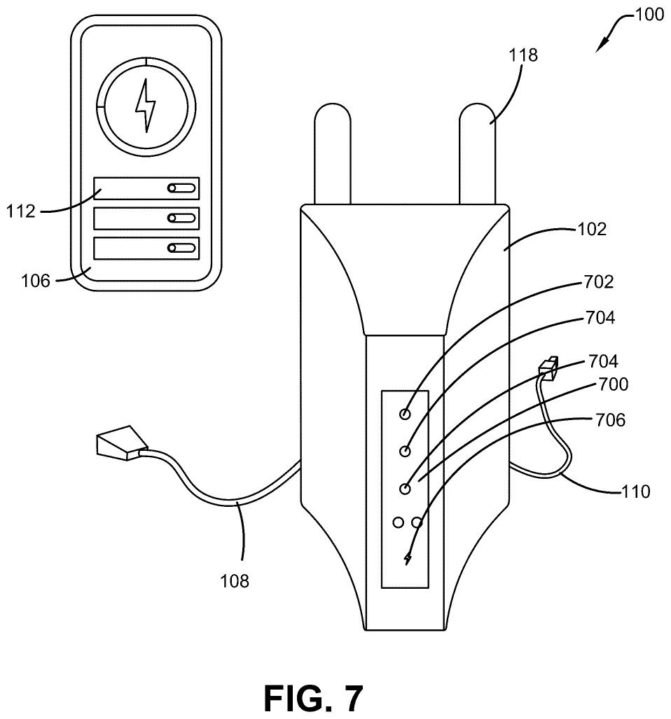

As shown in FIG. 7, the router component 102 will have a display mechanism 700 for providing a user 114 with an indication of the operating status of the wireless charger device 100. The display mechanism 700 may include, for example, a charging indicator 702 (i.e., an LED) that indicates to a user 114 that the wireless charger device 100 is receiving power. The charging indicator 702 may light up, for example, when the device 100 is receiving power. Further, the router component 102 can also include status lights 704 for internet, Wi-Fi, and ethernet ports. Additionally, a lightning bolt indicator 706 is lit whenever the router component 102 is emitting wireless power. In particular embodiments, the charging indicator 702 may comprise a signal-strength meter, allowing the user 114 to place the wireless charging modem device 100 in a location where the signal transmitting the power is the strongest.

Further, the wireless charging modem device 100 communicates with a mobile application 112 on a smart device 106 or another device needing charged. The mobile application 112 is a dedicated application that remotely monitors, controls, and manages the charging process and status of the smart devices 106. Generally, the mobile application 112 is downloaded onto the smart device 106 needing charged and allows a user 114 to monitor a smart device's charging status and receive notifications about the charging process. Further, the mobile application 112 alerts the user 114 of when the smart device 106 is fully charged and/or if any interruptions in charging have occurred. The mobile application 112 also allows for remote control of the charging and charge management, such that users 114 can schedule charging sessions or activate the charger device 100 remotely. Thus, scheduling of charging sessions helps with energy efficiency, especially if multiple devices 106 are needing charged. The mobile application 112 can also manage internet and Wi-Fi connectivity 104 of multiple smart devices 106 in communication with the wireless charging modem device 100. The Wi-Fi connectivity 104 also allows remote control and management of the charging, so users 114 may schedule charging sessions or activate the charger remotely via the mobile application 112.

Furthermore, the mobile application 112 also manages and facilitates data transfers between smart devices 106 on the same network for seamless file sharing, media streaming, and more. Thus, users 114 can share files or stream media via the wireless charging modem device 100 and can facilitate data transfer between the smart device 106 and other network-connected devices, as needed.

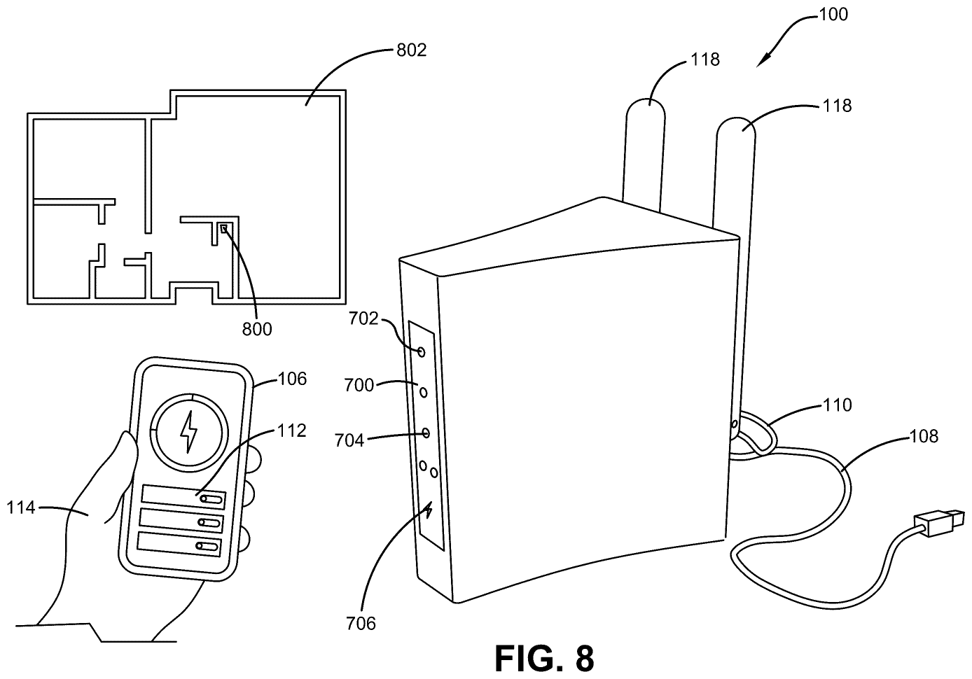

As shown in FIG. 8, the wireless charging modem device 100 is placed in a central location 800 within a house or building 802 and can wirelessly charge smart devices 106 that are set up with the mobile application 112 and within range of the wireless charging modem device 100.

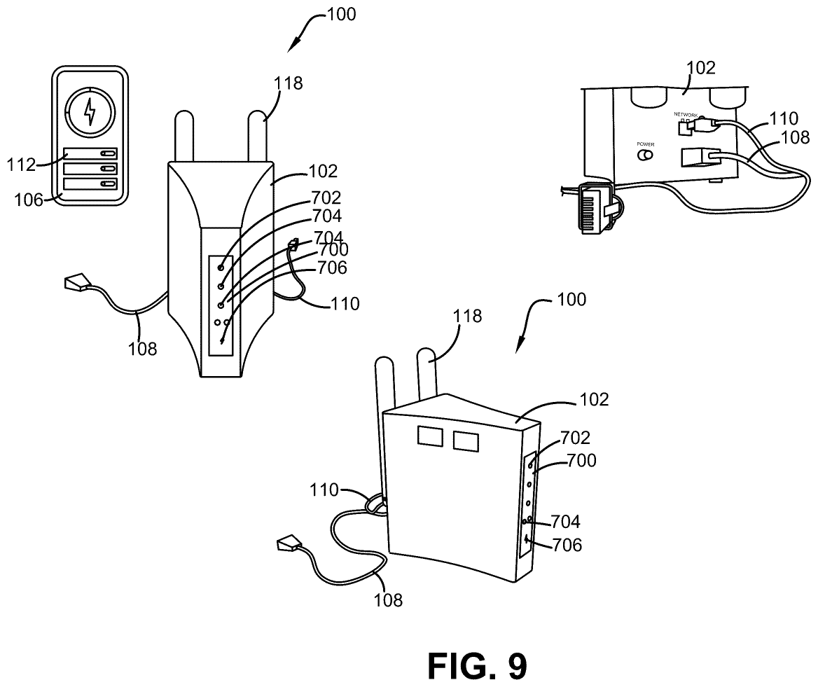

As shown in FIG. 9, the control logic 402 is capable of operating the wireless power-transmitting component 400 to wirelessly transmit power in accordance with a selectable power-transmitting protocol. These embodiments are referred to herein as programmable embodiments. In particular embodiments, the power-transmitting protocol is selected by a user 114 of the device 100. In particular embodiments, the power-transmitting protocol may be selected by the smart device 106 to be charged via the mobile application 112.

In particular embodiments, a selectable power-transmitting protocol may include, for example, a particular frequency at which the transmit circuitry 406 produces an alternating voltage that the transmit circuitry 406 supplies to the transmit coil 404. Thus, selecting a first power-transmitting protocol may cause the transmit circuitry 406 to produce an alternating voltage at a particular frequency and selecting a second power-transmitting protocol may cause the transmit circuitry 406 to produce and alternating voltage at a different frequency. Analogously, a particular power-transmitting protocol may include, for example, a particular level of intensity of an inductive field for the transmitting coil 404. Thus, selecting a first power-transmitting protocol may cause the transmit circuitry 406 to produce a particular level of intensity of the inductive field, whereas selecting a second power-transmitting protocol may cause the transmit circuitry 406 to produce a different level of intensity for the inductive field. Further, the control logic 402 can select a power-transmission protocol that is suited for charging a particular smart phone 106.

For example, a smart device 106 to be charged may be placed within range of the wireless charging modem device 100. If the smart device 106, via the mobile application 112, is capable of detecting that it is within range of the wireless charging modem device 100 and is capable of wirelessly communication with the device 100, the smart device 106 to be charged may transmit an identification of a power-transmitting protocol for the wireless charging modem device 100 to use when the device 100 charges the smart device 106. The wireless charging modem device 100 may receive the transmitted identification of a wireless power-transmitting protocol and transmit power to the smart device 106 in accordance with the identified protocol.

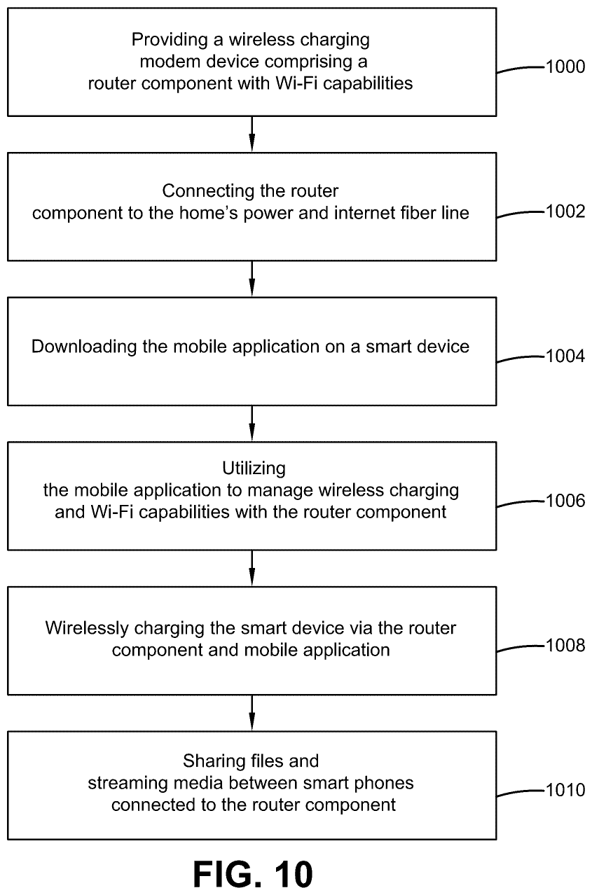

FIG. 10 illustrates a flowchart of the method of wirelessly charging a smart device. The method includes the steps of at 1000, providing a wireless charging modem device comprising a router component with Wi-Fi capabilities. The method also comprises at 1002, connecting the router component to the home's power and internet fiber line. Further, the method comprises at 1004, downloading the mobile application on a smart device. The method also comprises at 1006, utilizing the mobile application to manage wireless charging and Wi-Fi capabilities with the router component. The method comprises at 1008, wirelessly charging the smart device via the router component and mobile application. Finally, the method comprises at 1010, sharing files and streaming media between smart phones connected to the router component.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “wireless charging modem device”, “wireless charging device”, “modem device”, and “device” are interchangeable and refer to the wireless charging modem device 100 of the present invention.

Notwithstanding the forgoing, the wireless charging modem device 100 of the present invention can be of any suitable size and configuration as is known in the art without affecting the overall concept of the invention, provided that it accomplishes the above stated objectives. One of ordinary skill in the art will appreciate that the wireless charging modem device 100 as shown in FIGS. 1-10 is for illustrative purposes only, and that many other sizes and shapes of the wireless charging modem device 100 are well within the scope of the present disclosure. Although the dimensions of the wireless charging modem device 100 are important design parameters for user convenience, the wireless charging modem device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wireless charging modem device that provides a user with a means for wirelessly charging smart devices, the wireless charging modem device comprising:
a router component; and
a smart device with a mobile application;
wherein the router component comprises Wi-Fi capabilities, allowing the smart device to be connected to a home or office Wi-Fi network;
wherein the router component leverages inductive charging technology to wirelessly power the smart device; and
further wherein the router component communicates with the mobile application to monitor and manage the wireless charging.

2. The wireless charging modem device of claim 1, wherein the router component is configured to be plugged into a home's power and internet fiber line via power and internet cords.

3. The wireless charging modem device of claim 2, wherein the router component comprises a primary charging circuit for providing inductive power transfer.

4. The wireless charging modem device of claim 3, wherein the router component comprises wireless charging antennas.

5. The wireless charging modem device of claim 4 further comprising a plurality of indicia.

6. The wireless charging modem device of claim 5, wherein the router component comprises a wireless power-transmitting component which communicates with the smart device to charge it.

7. The wireless charging modem device of claim 6, wherein the router component comprises a control logic that is capable of transferring power received to the wireless power-transmitting component.

8. The wireless charging modem device of claim 7, wherein the power cord receives electrical power from a standard power source, such as a 120 V outlet commonly found in residential and office buildings to power the router component.

9. The wireless charging modem device of claim 8, wherein the wireless power-transmitting component includes a transmit coil and transmit circuitry, such that the transmit circuitry may produce an alternating voltage which is supplied to the transmit coil.

10. The wireless charging modem device of claim 9, wherein the control logic transfers power received by the router component to the wireless power-transmitting component.

11. The wireless charging modem device of claim 10, wherein the router component has a display mechanism for providing a user with an indication of operating status.

12. The wireless charging modem device of claim 11, wherein the mobile application is a dedicated application that remotely monitors, controls, and manages charging process and status of the smart device.

13. The wireless charging modem device of claim 12, wherein the mobile application is downloaded onto the smart device needing charged and allows a user to monitor a smart device's charging status and receive notifications about the charging process.

14. A wireless charging modem device that provides a user with a means for wirelessly charging smart devices, the wireless charging modem device comprising:
a router component with wireless charging antennas comprising a primary charging circuit for providing inductive power transfer; and
a smart device with a mobile application;
wherein the router component is configured to be plugged into a home's power and internet fiber line via power and internet cords;
wherein the power cord receives electrical power from a standard power source, such as a 120 V outlet commonly found in residential and office buildings to power the router component;
wherein the router component comprises Wi-Fi capabilities, allowing the smart device to be connected to a home or office Wi-Fi network;
wherein the router component leverages inductive charging technology to wirelessly power the smart device;
wherein the router component comprises a wireless power-transmitting component and control logic which communicates with the smart device to charge it;
wherein the router component has a display mechanism for providing a user with an indication of operating status;
wherein the mobile application is a dedicated application that remotely monitors, controls, and manages charging process and status of the smart device; and
further wherein the mobile application is downloaded onto the smart device needing charged and allows a user to monitor a smart device's charging status and receive notifications about the charging process.

15. The wireless charging modem device of claim 14, wherein the mobile application alerts a user of when the smart device is fully charged and/or if any interruptions in charging have occurred.

16. The wireless charging modem device of claim 14, wherein the mobile application allows for remote control of the charging and charge management, such that users can schedule charging sessions or activate the wireless charging modem device remotely.

17. The wireless charging modem device of claim 14, wherein the mobile application manages and facilitates data transfers between smart devices on same network for seamless file sharing and media streaming.

18. The wireless charging modem device of claim 14, wherein the wireless charging modem device is placed in a central location within a house or building and can wirelessly charge smart devices that are set up with the mobile application and within range of the wireless charging modem device.

19. The wireless charging modem device of claim 14, wherein the display mechanism includes status lights for power, internet, Wi-Fi, and ethernet ports, as well as a lightning bolt indicator which is lit whenever the router component is emitting wireless power.

20. A method of wirelessly charging a smart device, the method comprising the following steps:
providing a wireless charging modem device comprising a router component with Wi-Fi capabilities;
connecting the router component to the home's power and internet fiber line;
downloading the mobile application on a smart device;
utilizing the mobile application to manage wireless charging and Wi-Fi capabilities with the router component;
wirelessly charging the smart device via the router component and mobile application; and sharing files and streaming media between smart phones connected to the router component.
